(19) United States
(12) Patent Application Publication
(10) Pub. No.: US 2002/0087265 A1
(43) Pub. Date: Jul. 4, 2002

(54) Tightly coupled remote location device utilizing flexible circuitry

(76) Inventor: William E. Thacker, Durham, NC (US)

Correspondence Address: Arthur G. Yeager, P.A., Suite 1305, 112 West Adams Street, Jacksonville, FL, 32202, US

(21) Appl. No.: 09/907,800

(22) Filed: Jul. 18, 2001

Related U.S. Application Data
(60) Provisional application No. 60/219,784, filed on Jul. 19, 2000.

(51) Int. Cl. G01C 21/32

(52) U.S. Cl. 701/207; 455/456

(57) ABSTRACT

A device for the determination and communication of location information includes a position computation module for determining a location of the device and providing location data indicative of a location, a data link module for converting location data into a data stream for transmission from the device, a physical connection module operatively connected to the data link module for transmitting the data stream, and a processing unit for controlling each module.

### CROSS-REFERENCE TO RELATED APPLICATIONS

This application is related to Provisional Application, Serial No. 60/219,784, filed Jul. 19, 2000, entitled “TIGHTLY COUPLED REMOTE LOCATION DEVICE UTILIZING FLEXIBLE CIRCUITRY” and is related to a concurrently filed application entitled “COMMUNICATION PROTOCOL FOR A REMOTE LOCATOR SYSTEM”.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The present invention pertains generally to location-oriented security devices and communication systems, and more particularly to a remote locator system for delivering precise location information on demand.

2. Related Art

In many and various fields it is useful to have knowledge of the precise geographic location of a person or object. For example, if an individual is mentally handicapped, it would be desirable to continuously know the individual's exact whereabouts in order to ensure his well-being. Similarly, it would be useful to know in real time the location of a delivery person in the field so that more efficient delivery scheduling may be accomplished. A multitude of other applications for geographic location information can be found in the commercial sector, civilian agencies, governmental agencies, law enforcement agencies, and the military. With the arrival of the Global Positioning System (GPS), which provides three-dimensional coordinates of any location on Earth, such remote locator systems have become a practicality.

Location-oriented security devices should be easily concealed. None of the devices known to the prior art combine tightly-coupled circuitry, flexible circuitry, and remote location sensing and signaling in a satisfactory manner to create a small, highly reliable and easily concealed location device.

### BRIEF DESCRIPTION OF THE SEVERAL VIEWS OF THE DRAWING

The novel features which are believed to be characteristic of this invention are set forth with particularity in the appended claims. The invention itself, however, both as to its organization and method of operation, together with further objects and advantages thereof, may best be understood by reference to the following description, taken in connection with the accompanying drawings, in which:

FIG. 1 is a block diagram of the tightly-coupled electronic design of the location device in accord with the present invention; and

FIGS. 2-6 are block diagrams of locator devices in accord with the present invention.

### BRIEF SUMMARY OF THE INVENTION

In one aspect of the present invention there is provided a device for the determination and communication of location information comprising a position computation module for determining a location of a device and providing location data indicative of a location, a data link module for converting the location data into a data stream for transmission from the device, a physical connection module operatively connected to the data link module for transmitting the data stream, and a processing unit for controlling each module. The electronic design of the device is tightly coupled to provide that the location data can be passed directly from the position computation module to the data link module without modification or manipulation. The design of the device is tightly coupled to also provide that the data stream can be passed directly from the data link module to the physical connection module without modification or manipulation. The device is constructed as a flexible circuit to allow for bending and distorting of the device without impairment of the operation of the device.

The position computation module includes global positioning system receiver circuitry and alternatively, the position computation module includes receiver means for receiving signals from a plurality of fixed position transmitters.

In another aspect of the present invention there is provided a device for the determination and communication of location information comprising a position computation module for determining a location of the device and providing location data indicative of a location, a data link transceiver module for converting the location data into a data stream and for receiving a data stream for transmission from the device, a physical connection transceiver module operatively connected to the data link module for transmitting the data stream and receiving a data stream, and a processing unit for controlling each module. The electronic design of the device is tightly coupled to provide that the location data can be passed directly between the position computation module and the data link module without modification or manipulation, and to provide that the data stream can be passed directly between the data link module and the physical connection module without modification or manipulation. The device is constructed as a flexible circuit to allow for bending and distorting of the device without impairment of the operation of the device.

The position computation module includes either global positioning system receiver circuitry or receiver means for receiving signals from a plurality of fixed position transmitters.

### DETAILED DESCRIPTION OF THE INVENTION

### INTRODUCTION

Definitions

1. A remote location device is an independent electronic assembly that has a means for establishing its location and an ability to communicate that location to a querying agent.

2. Tightly coupled refers to the electronic digital design method of using a single processing element such as a microprocessor within an independent electronic assembly to control multiple interface, computation, or storage modules in order to reduce physical size and replication cost.

3. Flexible circuitry is a manufacturing method, which provides component mounting and electrical interconnection within an electrical assembly using a semi-rigid substrate.

Description Overview

Purpose—This invention applies the tightly coupled electronic design method and flexible circuit manufacturing method to remote location devices in order to produce an independent electronic assembly that is small in size and with the ability to bend and distort.

Parts—The three items described within this application consist of an electronic circuit (remote location device), a method of designing such a circuit (tightly coupled), and a method of manufacturing the circuit (flexible circuitry).

I. Remote Location Device

The Remote Location Device preferably consists of fours distinct electronic modules.

1. The position computation module receives external signals and computes absolute two or three-dimensional geographic coordinates from these signals. Examples of this module are (but are not limited to):

Global Positioning System—The module accepts signals from satellites in orbit that represent time information. Information from at least three satellites are used to compute terrestrial position using triangulation.

Fixed Transmitter System—The module accepts signals from fixed position transmitters that represent time information. Information from three transmitters is used to compute the relative position referenced to the position of the transmitters using triangulation.

Dead Reckoning System—The module accepts sensor data that represents linear position velocities and vectors. By storing the initial position, a new position is computed using the sensor data.

2. The data link module encodes and decodes the position information into a data stream suitable for transmission or reception. Examples of this module are (but are not limited to):

Data Modems—The module accepts digital position data and encodes the data using different frequency modulation schemes within the audio range for the purpose of transmitting digital information.

ASCII Encoding—The module accepts digital position information and encodes this data in ASCII (American Standard for Information Interchange) format. This data is further encoded into a single bit stream for the purpose of transmission using a simple frequency modulation scheme such as no return to zero (NRZ).

TCP/IP Protocol—The modules accept digital position information, encode the data into an intermediate form, and prepare packets for transmission using an Internet Protocol (IP).

3. The physical connection module sends and receives the data stream. Examples of this module are (but are not limited to):

Cellular Telephony—The module accepts audio information from a data modem and transmits/receives data via a cellular phone protocol such as Advanced Mobile Phone Service (AMPS), Coded Division Multiple Access (CDMA), or Global System for Mobile communications (GSM).

Spread Spectrum—The module accepts audio information from a single bit stream source such as an ASCII encoding NRZ stream and transmits/receives data using Spread Spectrum where the transmitter takes the input data and spreads it in a predefined method. Each receiver must understand this predefined method and despread the signal before the data can be interpreted. There are two basic methods to performing the spreading: (1) Frequency Hopping, and (2) Direct Sequencing. Frequency hopping spreads its signals by “hopping” the narrow band signal as a function of time. Direct sequencing spreads its signal by expanding the signal over a broad portion of the radio band. The FCC allows the use of Spread Spectrum technology in three radio bands, 902-928 MHz, 2400-2483.5 MHz and 5752.5-5850 MHz for transmission under 1 Watt of power. This power limit prevents interference within the band over long distances.

Ethernet—The module accepts packet data suitable for transmission over a single cable. When two packets are transmitted at the same time a collision occurs, is detected, and the packets are retransmitted at different times.

4. The processing unit controls the information flow between the individual modules within the remote location device. This module may also include random access memory for temporary storage, flash memory for semi-permanent storage, or read only memory for fixed storage. Examples of the processing element within this module are (but are not limited to):

1) Complex Instruction Set Computers (CISC) such as Intel's Pentium or Motorola's 680x0.

2) Reduced Instruction Set Computers (RISC) such as Motorola's Power PC or Sun Microsystem's SPARC.

3) Microcontrollers such as Motorola's 68HC11 or Intel's 8051.

II. Tightly Coupled

This electronic design method reduces the number of components required for a complete functional circuit by implementing the control elements for each separate data manipulation module with a single processing element. Each module must be tightly coupled where data can be passed from one module to another without modification or manipulation. This allows the use of a single processing element. Preferably, the processing unit does not connect to the data flow path and is not involved in data manipulation. The processing unit can be used for data computations if necessary, however, this will reduce the speed and performance of the circuit. There may be example applications where speed is of less importance than reduced component count; hence, the design tradeoff of using the processing unit to manipulate data is chosen.

III. Flexible Circuitry

The use of flexible circuitry when manufacturing a tightly coupled location device creates an electronic assembly that is small in size, capable of bending and distorting, and not obvious to an observing individual looking for such a device.

A single sided flex circuit (basic) consists of a flexible polymer film laminated to a thin piece of copper. It is then chemically etched to produce a circuit pattern. Patterns can be created on both sides of the substrate film (double sided) with via plated-through holes. The vias are to make electrical connections between the two layers. A covercoat made of polymer is added to insulate the copper foil. Manufacturers such as Flextronics Inc., PolyFlex, Inc. and All-Flex, Inc. specialize in this manufacturing process.

TABLE I

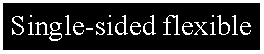

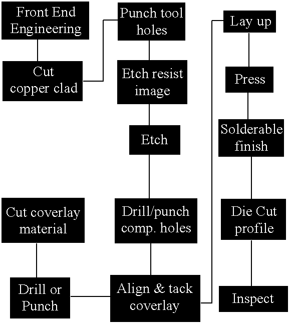

The remote location device is packaged into a small flexible electronic assembly that can be concealed when placed on the person or object that is to be located. The combination of the tightly coupled design and flexible circuit manufacturing methods when applied to a remote location device enables the creation of a wide variety of security products with a number of different applications.

Electronic Design

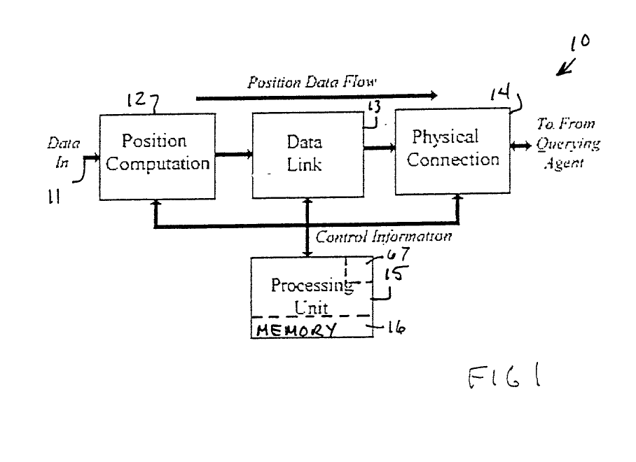

With reference now to the drawings, the electronic design of the present invention is illustrated generally at numeral 10 in FIG. 1. Data input 11 is provided to position computation circuitry 12, which provides data to data link 13. The sending and receiving of data is accomplished via the physical connection module 14.

The processing unit 15 is not in the data flow and is not involved in data manipulation. Unit 13 does control the flow between the modules. Memory 16 provides for data storage as understood in the art.

Table I illustrates a representative manufacturing process for the flexible circuitry of the design of a remote location device.

Applications

1. Locator Device

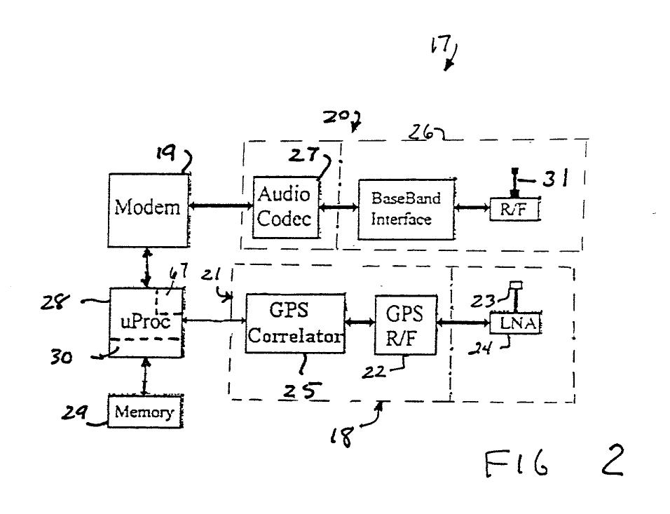

The locator device 17 of FIG. 2 communicates terrestrial position information to a remote location over a secure channel for the purpose of locating an individual. In this application the position computation module 18 uses the Global Positioning System (GPS), the data link module is a data modem 19, and the physical connection module is an analog cellular radio 20. A detailed description of these components follows:

The Global Positioning System component 21 utilizes a receiver 22 that accepts low signal level radio frequency carriers from fixed orbit satellites via a micro strip patch antenna 23. The signal to noise ratio of these signals are increased with a low noise amplifier 24 and translated into precise time information. This information is passed to a correlation component 25 that computes two-dimensional or three-dimensional terrestrial position.

The data modem 19 utilizing standard modulation schemes such as trellis coded (V.34, V.32 bis), quadrature amplitude (V.32, V.22 bis), differential phase shift keyed (V.22, Bell 212A), frequency shift keying (V.21), and frequency shift keying (Bell 103J) acts as an interface between the GPS output and the physical connection 20.

The Cellular Analog Mobile Phone System (AMPS) radio transceiver component 26 includes an RF transceiver and baseband interface as understood in the art and is compatible with current cellular systems (IS-19B) which transmits and receives radio frequency data via a dipole antenna 31, modulates and demodulates the radio frequency signals, and translates the signal stream into the audio range using an Audio Codec 27.

The microprocessor 28, memory 29, and microcode 30 components are used to control all the functions within the device. The use of a single processor 28 tightly couples the components allowing a small physical footprint.

Flexible circuit layout using a two-layer polymide laminate process allows for the packaging of the device into, bands, belts, and other forms.

2. Perimeter Locator Device

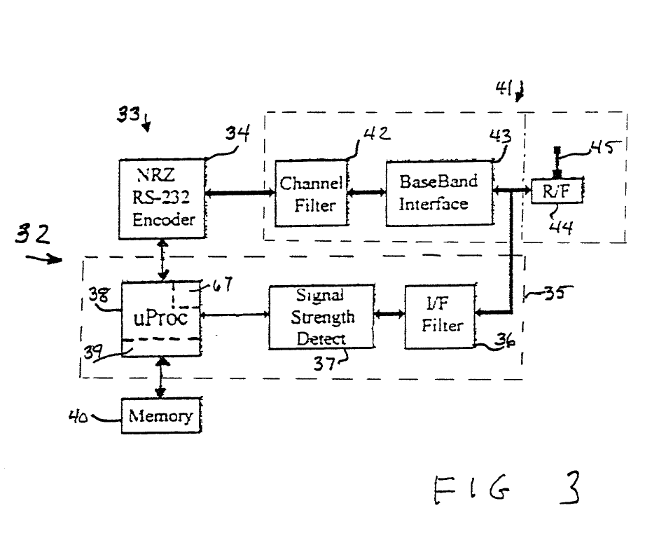

A perimeter locator device 32 of FIG. 3 communicates position information within a fixed area to a remote location over for the purpose of locating an object within that fixed area. In this application the position computation module 35 uses fixed transmitters and a triangulation algorithm in order to compute position, the data link module 33 uses an ASCII coded NRZ code to provide a data stream, and the physical connection module 41 is a dedicated spread spectrum radio frequency radio transceiver. A detailed description of these components follows:

The triangulation component utilizes a receiver 44 that accepts radio frequency carriers from fixed transmitters within the perimeter via a dipole antenna 45. The signal is filtered to an intermediate frequency at 36 that contains fixed transmitter information. This information is passed to a signal strength measuring component 37. This information is passed to the main processor 38, which uses triangulation to compute position.

The ASCII (American Standard for Information Interchange) encoder 34 and NRZ (non-return to zero) modulation converts the position information into a single data stream.

The spread spectrum radio transceiver component 44 transmits and receives radio frequency data via a dipole antenna 45, modulates and demodulates the radio frequency signals, and translates the signal stream into a digital stream.

The microprocessor 38, memory 40, and microcode 39 components are used to control all the functions within the device. The use of a single processor tightly couples the components allowing a small physical footprint.

Flexible circuit layout using a two-layer polymide laminate process allows for the packaging of the device into, bands, belts, and other wearable forms.

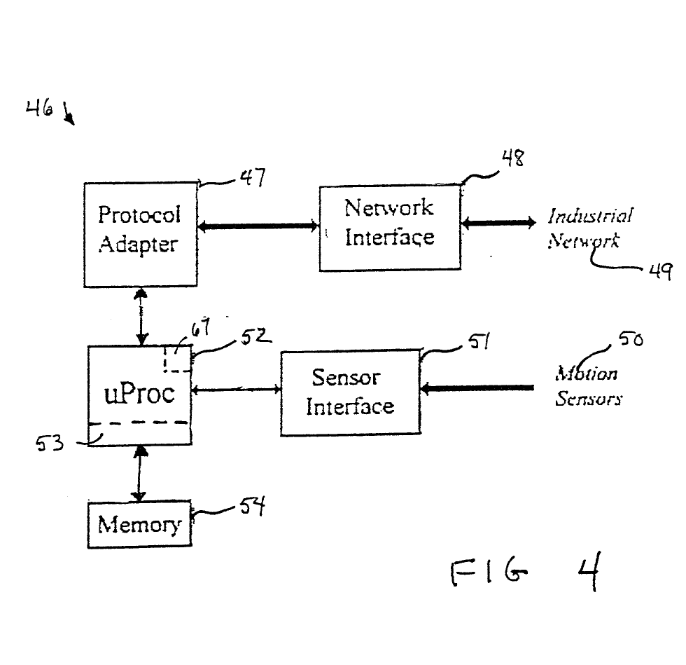

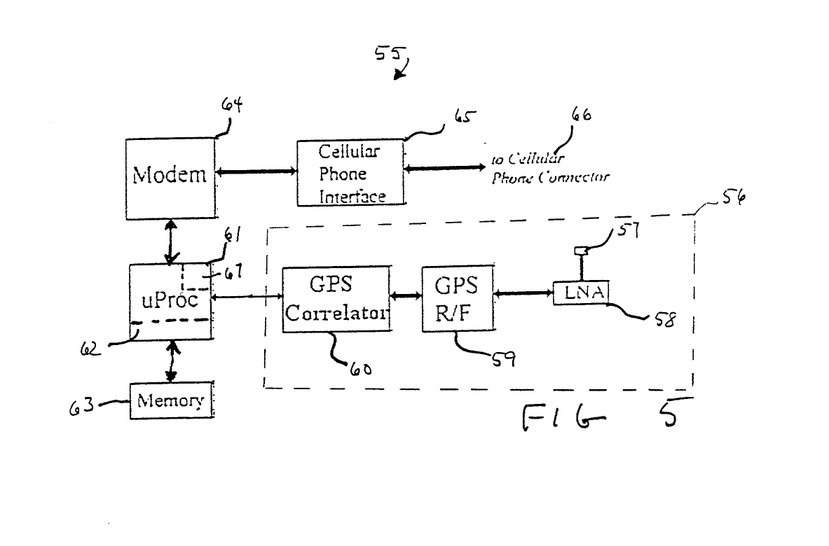

An industrial locator device 46 (FIG. 4) communicates position information to a remote location over for the purpose of manipulating an object within a fixed area. In this application the position computation module uses external sensors 50 to constantly update the position of the object. The data link module 47 uses a standard network connection protocol (TCP/IP) to provide a data stream, and the physical connection module is a dedicated network transceiver (Ethernet). A detailed description of these components follows:

The position computation component 50, 51, 52 samples data from sensors that change when the object's position changes. This information is passed via interface 51 to the main processor 52, which uses the previous old position and the new sensor data in order to compute position.

The protocol adapter 47 (data link) component provides a data stream by encoding and decoding information utilizing the TCP/IP protocol.

The physical connection module is network interface component 48, which transmits and receives data via a cable using the Ethernet protocol.

The microprocessor 52, memory 54, and microcode 53 components are used to control all the functions within the device. The use of a single processor tightly couples the components allowing a small physical footprint.

Flexible circuit layout using a two-layer polymide laminate process allows for the packaging of the device into forms that fit into small multiple and odd-shaped carriers or objects in industrial environments.

Battery 67 is shown as the same in all embodiments, but may be different in various applications as understood in the art.

Table I is summary of the steps used in forming a single-sided flexible circuit in accord with the present invention.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

What is claimed as new and what it is desired to secure by Letters Patent of the United States is:

1. A device for the determination and communication of location information comprising a position computation module for determining a location of said device and providing location data indicative of a location, a data link module for converting said location data into a data stream for transmission from said device, a physical connection module operatively connected to said data link module for transmitting said data stream, and a processing unit for controlling each said module.

2. The device as defined in claim 1 wherein the electronic design of said device is tightly coupled to provide that said location data can be passed directly from said position computation module to said data link module without modification or manipulation.

3. The device as defined in claim 1 wherein the electronic design of said device is tightly coupled to provide that said data stream can be passed directly from said data link module to said physical connection module without modification or manipulation.

4. The device as defined in claim 1 wherein the electronic design of said device is tightly coupled to provide that said location data can be passed directly from said position computation module to said data link module without modification or manipulation and to provide that said data stream can be passed directly from said data link module to said physical connection module without modification or manipulation, said device being constructed as a flexible circuit to allow for bending and distorting of said device without impairment of the operation of said device.

5. The device as defined in claim 1 wherein said device is constructed as a flexible circuit to allow for bending and distorting of said device without impairment of the operation of said device.

6. The device as defined in claim 1 wherein the electronic design of said device is tightly coupled to provide that said location data can be passed directly from said position computation module to said data link module without modification or manipulation and wherein said device is constructed as a flexible circuit to allow for bending and distorting of said device without impairment of the operation of said device.

7. The device as defined in claim 1 wherein the electronic design of said device is tightly coupled to provide that said data stream can be passed directly from said data link module to said physical connection module without modification or manipulation and wherein said device is constructed as a flexible circuit to allow for bending and distorting of said device without impairment of the operation of said device.

8. The device as defined in claim 1 wherein said position computation module includes global positioning system receiver circuitry.

9. The device as defined in claim 1 wherein said position computation module includes receiver means for receiving signals from a plurality of fixed position transmitters.

10. A device for the determination and communication of location information comprising a position computation module for determining a location of said device and providing location data indicative of a location, a data link transceiver module for converting said location data into a data stream and for receiving a data stream for transmission from said device, a physical connection transceiver module operatively connected to said data link module for transmitting said data stream and receiving a data stream, and a processing unit for controlling each said module.

11. The device as defined in claim 10 wherein the electronic design of said device is tightly coupled to provide that said location data can be passed directly between said position computation module and said data link module without modification or manipulation.

12. The device as defined in claim 10 wherein the electronic design of said device is tightly coupled to provide that said data stream can be passed directly between said data link module and said physical connection module without modification or manipulation.

13. The device as defined in claim 10 wherein the electronic design of said device is tightly coupled to provide that said location data can be passed directly between said position computation module and said data link module without modification or manipulation and to provide that said data stream can be passed directly between said data link module and said physical connection module without modification or manipulation, said device being constructed as a flexible circuit to allow for bending and distorting of said device without impairment of the operation of said device.

14. The device as defined in claim 10 wherein said device is constructed as a flexible circuit to allow for bending and distorting of said device without impairment of the operation of said device.

15. The device as defined in claim 10 wherein the electronic design of said device is tightly coupled to provide that said location data can be passed directly between said position computation module and said data link module without modification or manipulation and wherein said device is constructed as a flexible circuit to allow for bending and distorting of said device without impairment of the operation of said device.

16. The device as defined in claim 10 wherein the electronic design of said device is tightly coupled to provide that said data stream can be passed directly between said data link module and said physical connection module without modification or manipulation and wherein said device is constructed as a flexible circuit to allow for bending and distorting of said device without impairment of the operation of said device.

17. The device as defined in claim 10 wherein said position computation module includes global positioning system receiver circuitry.

18. The device as defined in claim 10 wherein said position computation module includes receiver means for receiving signals from a plurality of fixed position transmitters.

19. The device as defined in claim 13 wherein said position computation module includes global positioning system receiver circuitry.

20. The device as defined in claim 13 wherein said position computation module includes receiver means for receiving signals from a plurality of fixed position transmitters.
